(19) United States
(12) Patent Application Publication
(10) Pub. No.: US 2010/0254863 A1
(43) Pub. Date: Oct. 7, 2010

(54) Sterilant gas generating system

(76) Inventors: Sang Hun Lee, San Ramon, CA (US); Joong Soo Kim, Los Altos, CA (US); Jae-Mo Koo, Palo Alto, CA (US); Andrew Way, Sunnyvale, CA (US); Orion Weihe, Fremont, CA (US); Jeff Ifland, Cupertino, CA (US)

Correspondence Address: JORDAN AND HAMBURG LLP, 122 EAST 42ND STREET, SUITE 4000, NEW YORK, NY, 10168, US

(21) Appl. No.: 12/384,536

(22) Filed: Apr. 6, 2009

(51) Int. Cl. B01J 19/08

(52) U.S. Cl. 422/186

(57) ABSTRACT

A sterilant gas generating system includes a chamber for containing gas; a gas converting device having a gas inlet and a gas outlet connected to the chamber and adapted to convert gas received through the gas inlet into a sterilant gas and to eject the sterilant gas into the chamber through the gas outlet; and a gas recirculating mechanism coupled to the chamber and the gas inlet of the converting means and operative to move the gas contained in the chamber to the gas inlet of the gas converting device.

### BACKGROUND OF THE INVENTION

1. Field of the Invention

The present invention relates to sterilant gas generating systems, and more particularly to devices for generating sterilant gas using microwave energy.

2. Discussion of the Related Art

Steam autoclaving is the most commonly accepted standard for sterilizing most medical instruments. During sterilization, the instruments are exposed to steam at 121° C. at 15-20 lbs of pressure for 15-30 minutes. One of the disadvantages of autoclaving method is not suitable for plastics and other heat labile materials.

As an alternative, various sterilant gases, such as nitric oxide, nitrogen dioxide, sulfur dioxide, hydrogen peroxide, chlorine dioxide, carbon dioxide, ozone, and ethylene oxide, have been used to kill or control the growth of microbial contaminations. In conventional systems, generating and handling these sterilant gases in high concentrations represents hazard to the human operators, which may impose a limit on the allowable concentration of gas unless an effective approach to resolve this safety issue is provided. It is because if the concentration of the sterilant gas needs be decreased due to safety concerns, the exposure time required to complete a sterilization process must be increased. Thus, there is a need for methods and devices that can generate sterilant gases of high concentration in a safe and efficient manner so that the potential hazard to human operators can be minimized.

### SUMMARY OF THE INVENTION

According to one aspect of the present invention, a system for generating a target gas by using microwave energy includes a chamber for containing gas; a gas converting device having a gas inlet and a gas outlet connected to the chamber and adapted to convert gas received through the gas inlet into a target gas and to eject the target gas into the chamber through the gas outlet; and a gas recirculating mechanism coupled to the chamber and the gas inlet of the converting means and operative to move the gas contained in the chamber to the gas inlet of the gas converting device.

According to another aspect of the present invention, a system for generating a target gas includes: a microwave generator for generating microwave energy; a power supply connected to the microwave generator for providing power thereto; a microwave cavity; a waveguide operatively connected to the microwave cavity for transmitting microwave energy thereto; an isolator for dissipating microwave energy reflected from the microwave cavity; and at least one nozzle coupled to the microwave cavity. Each nozzle includes: a housing having a generally cylindrical space formed therein and a through hole, the space forming a gas flow passageway and being in fluid communication with the through hole; and a rod-shaped conductor disposed in the space and having a portion extending into the microwave cavity for receiving microwave energy and operative to transmit microwave energy along a surface thereof so that the microwave energy transmitted along the surface excites gas flowing through the space into the target gas. The system also includes a chamber operatively coupled to the space and adapted to receive the target gas from the nozzle; and a gas recirculating mechanism coupled to the chamber and the through hole formed in the housing and operative to move the gas contained in the chamber to the through hole.

According to another aspect of the present invention, a system for generating a target gas includes: a microwave generator for generating microwave energy; a power supply connected to the microwave generator for providing power thereto; a microwave cavity; a waveguide operatively connected to the microwave cavity for transmitting microwave energy thereto; an isolator for dissipating microwave energy reflected from the microwave cavity; a chamber for containing gas; and a tube formed of material transparent to microwave and passing through the cavity and having an upstream end and a downstream end and configured to convert gas flowing therethrough into a target gas by use of the microwave energy in the microwave cavity. The chamber is operatively coupled to the downstream end of the tube and adapted to receive the target gas from the tube. The system also includes a gas recirculating mechanism coupled to the chamber and the upstream end of the tube and operative to move the gas contained in the chamber to the upstream end of the tube.

The above, and other objects, features and advantages of the present invention will become apparent from the following description read in conjunction with the accompanying drawings, in which like reference numerals designate the same elements. The present invention is considered to include all functional combinations of the above described features and is not limited to the particular structural embodiments shown in the figures as examples. The scope and spirit of the present invention is considered to include modifications as may be made by those skilled in the art having the benefit of the present disclosure which substitute, for elements or processes presented in the claims, devices or structures or processes upon which the claim language reads or which are equivalent thereto, and which produce substantially the same results associated with those corresponding examples identified in this disclosure for purposes of the operation of this invention. Additionally, the scope and spirit of the present invention is intended to be defined by the scope of the claim language itself and equivalents thereto without incorporation of structural or functional limitations discussed in the specification which are not referred to in the claim language itself. Still further it is understood that recitation of the preface of “a” or “an” before an element of a claim does not limit the claim to a singular presence of the element and the recitation may include a plurality of the element unless the claim is expressly limited otherwise. Yet further it will be understood that recitations in the claims which do not include “means for” or “steps for” language are not to be considered limited to equivalents of specific embodiments described herein.

### BRIEF DESCRIPTION OF THE DRAWINGS

FIG. 1 shows a schematic diagram of an NO_{X} generating system in accordance with one embodiment of the present invention.

FIG. 2 shows an exploded view of a portion of the NO_{X} generating system of FIG. 1.

FIG. 3 shows a side cross-sectional view of a portion of the NO_{X} generating system of FIG. 1, taken along the line III-III.

FIG. 4 shows a schematic diagram of an NO_{X} generating system in accordance with another embodiment of the present invention.

FIG. 5 shows a schematic diagram of an NO_{X} generating system in accordance with yet another embodiment of the present invention.

FIG. 6 shows a schematic diagram of an NO_{X} generating system in accordance with still another embodiment of the present invention.

### DETAILED DESCRIPTION OF THE PREFERRED EMBODIMENTS

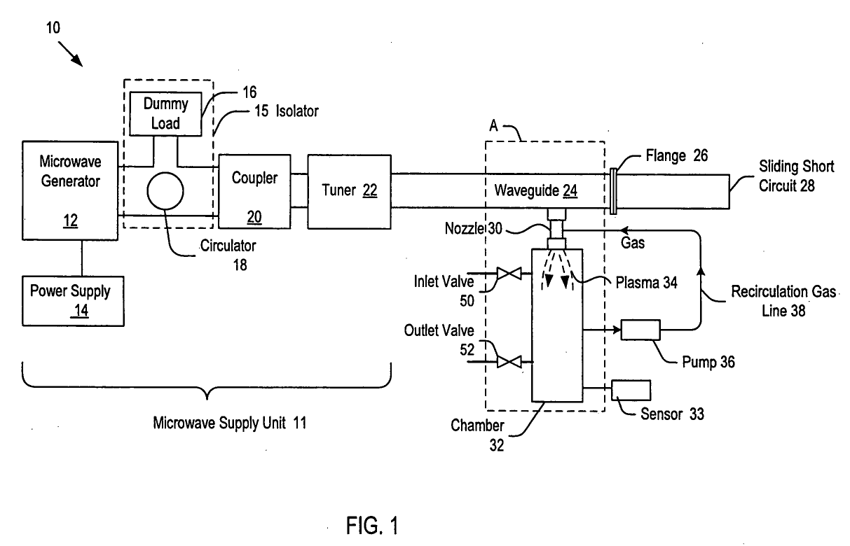

FIG. 1 shows a schematic diagram of an NO_{X} generating system 10 in accordance with one embodiment of the present invention. It is noted that the disclosed exemplary embodiments of the present invention are directed to generating and handling NO_{X}, such as NO and NO₂. However, it should be apparent to those of ordinary skill in the art that the disclosed embodiments can be used to generate and handle other types of sterilant gases (or, equivalently, target gases), such as CO₂, ClO₂, SO₂, H₂O₂, CO₂, O₃, and EtO.

As depicted in FIG. 1, the system 10 includes: a microwave cavity/waveguide 24; a microwave supply unit 11 for providing microwave energy to the microwave waveguide 24; a nozzle 30 connected to the microwave waveguide 24 and operative to receive microwave energy from the microwave waveguide 24 and excite gas by use of the received microwave energy; a sliding short circuit 28 disposed at the end of the waveguide 24; a chamber 32 for receiving and containing the gas that exits the nozzle 30; a pump 36 for recirculating the NO_{X} containing gas contained in the chamber 32 via a recirculation gas line 38; a sensor 33 for measuring the NO_{X} concentration in the chamber 32; an inlet valve 50; and an outlet valve 52. The nozzle 30 may excite the gas provided via the recirculating gas line 38 into plasma 34.

The inlet valve 50 is used to fill the chamber 32 with gas including nitrogen and oxygen. Upon filling the chamber 32 to a preset pressure, the inlet valve 50 is closed. Then, the microwave supply unit 11 is operated to generate plasma at the nozzle 30 and the pump 36 is operated to recirculate the gas contained in the chamber 32 so that the gas contained in the chamber 32 includes NO_{X}. It is noted that those skilled in the art will understand that the volume fractions of nitrogen and oxygen introduced in the chamber 32 via the inlet valve 50 may be varied according to the intended concentration of the target sterilant gas component contained in the chamber 32 and various types of sensors can be used to measure the concentration of the target gas component. The outlet valve 52 may be connected to another device (not shown in FIG. 1), such as sterilization chamber, that utilizes the NO_{X} gas discharged from the chamber 32 through the outlet valve 52. The inlet valve 50 and the outlet valve 52 are secured to the sidewall of the chamber 32. However, it should be apparent to those of ordinary skill in the art that these valves can be disposed in any other suitable locations without deviating from the spirit and scope of the present teachings.

As discussed above, the system 10 can be used to generate other types of sterilant gases. For example, the system 10 can be used to generate ozone by introducing pure oxygen into the chamber 32 via the inlet valve 50. In another example, the system 10 can be used to generate chlorine dioxide by introducing a mixture of oxygen and chlorine into the chamber 32 via the inlet valve 50.

The microwave supply unit 11 provides microwave energy to the microwave waveguide 24 and includes: a microwave generator 12 for generating microwaves; a power supply 14 for supplying power to the microwave generator 12; and an isolator 15 having a dummy load 16 for dissipating reflected microwave energy that propagates toward the microwave generator 12 and a circulator 18 for directing the reflected microwave energy to the dummy load 16.

The microwave supply unit 11 may further include a coupler 20 for measuring fluxes of the microwave energy; and a tuner 22 for reducing the microwave energy reflected from the sliding short circuit 28. The components of the microwave supply unit 11 shown in FIG. 1 are listed herein for exemplary purposes only. Also, it is possible to replace the microwave supply unit 11 with any other suitable system having the capability to provide microwave energy to the microwave waveguide 24 without deviating from the spirit and scope of the present teachings. Likewise, the sliding short circuit 28 may be replaced by a phase shifter that can be configured in the microwave supply unit 11. Optionally, a phase shifter (not shown in FIG. 1) may be mounted between the isolator 15 and the coupler 20.

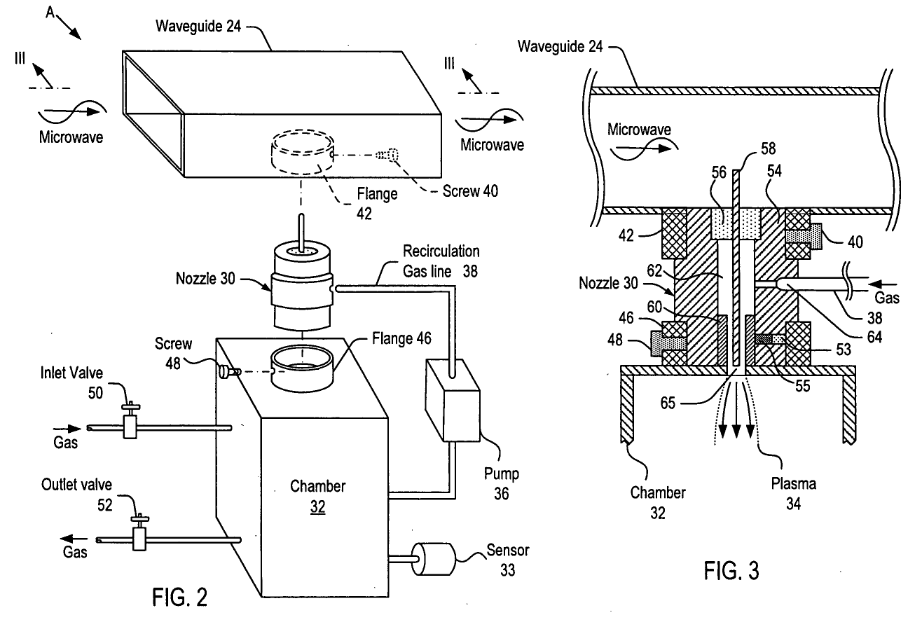

FIG. 2 shows an exploded view of a portion A of the NO_{X} generating system 10 of FIG. 1.

FIG. 3 shows a side cross-sectional view of the portion A of the NO_{X} generating system 10, taken along the line III-III. As depicted, a ring-shaped flange 42 is affixed to the bottom surface of the microwave cavity 24 and the nozzle 30 is secured to the ring-shaped flange 42 by one or more suitable fasteners 40, such as screws.

The nozzle 30 includes a rod-shaped conductor 58; a housing or shield 54 formed of conducting material, such as metal, and having a generally cylindrical cavity/space 62 formed therein so that the space forms a gas flow passageway; an electrical insulator 56 disposed in the space and adapted to hold the rod-shaped conductor 58 relative to the shield 54; a dielectric tube (such as quartz tube) 60; a spacer 55; and a fastener 53, such as a metal screw, for pushing the spacer 55 against the dielectric tube 60 to thereby secure the dielectric tube 60 to the housing 54. The spacer 55 is preferably formed of dielectric material, such as Teflon®, and functions as a buffer for firmly pushing the dielectric tube 60 against the shield 54 without cracking the dielectric tube 60.

The top portion (or, equivalently, proximal end portion) of the rod-shaped conductor 58 functions as an antenna to pick up microwave energy in the microwave cavity 24. The microwave energy captured by the rod-shaped conductor 58 flows along the surface thereof. The gas supplied via a gas line 38 passes through the gas inlet 64 is injected into the space 62 and excited by the microwave energy flowing along the surface of the rod-shaped conductor 58 and exits through the gas outlet 65. Plasma 34 may be formed at the bottom tip portion (or, equivalently, distal end portion) of the rod-shaped conductor 58.

In the plasma 34, the gas including nitrogen and oxygen molecules chemically react to generate various types of gas species including NOx and free radicals. In the process of recirculating the gas contained in the chamber 32 via the recirculation gas line 38, the gas passes through the gas inlet 64, the plasma 34 continuously generates the NOx particles and, as a consequence, the concentrations of NOx particles in the chamber 34 increase quite rapidly. Also, during the recirculation process, the recirculated NOx species and free radicals participate in the chemical reactions in the plasma 34 to thereby promote the chemical reactions. When the concentration of the NOx species in the chamber 32 reaches an intended level, the gas contained in the chamber 32 may be discharged to a device (not shown in FIGS. 1-3), such as a sterilization apparatus, via the outlet valve 52.

A ring-shaped flange 46 is affixed to the top surface of the chamber 32 and the nozzle 30 is secured to the ring-shaped flange 46 by one or more suitable fasteners 48, such as screws. It is noted that the nozzle 30 may be secured to the chamber 32 by any other suitable types of securing mechanisms.

The rod-shaped conductor 58, the dielectric tube 60, and the electric insulator 56 have functions similar to those of their counterparts of a nozzle described in U.S. Pat. No. 7,164,095, which is herein incorporated by reference in its entirety. For brevity, these components are not described in detail in the present document.

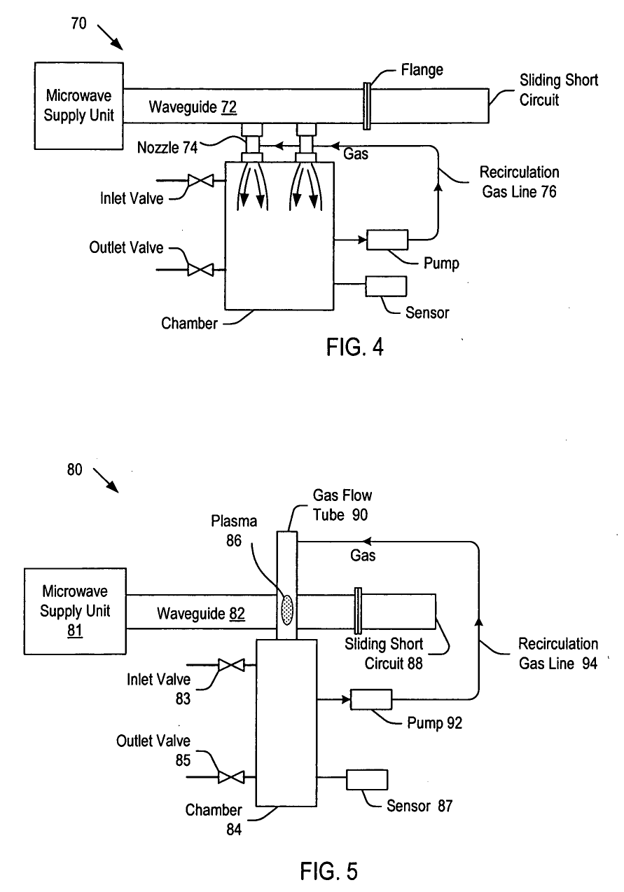

FIG. 4 shows a schematic diagram of an NOx generating system 70 in accordance with another embodiment of the present invention which has parts configured and arranged as in the first embodiment of FIGS. 1-3 except for differences noted herein. As depicted, the system 70 is similar to the system 10, with a difference in a number of nozzles 74 attached to the waveguide 72. The nozzle 74 may be similar to the nozzle 30 in FIGS. 1-3. A recirculation gas line 76 has one or more manifolds (not shown in FIG. 4) to provide the recirculated gas to the nozzles 74.

In the nozzles 30, 74, the threshold intensity of the microwave energy required to ignite plasma can be controlled if the point where the microwave energy is focused can be moved relative to the nozzle exit. Typically, the microwave energy is focused at the bottom tip portion of the rod-shaped conductor. Thus, to control the plasma ignition, a mechanism to move the rod-shaped conductor relative to the nozzle housing can be installed in each of the nozzles 30, 74. More detailed information of the mechanism to move the rod-shaped conductor can be found in U.S. patent application Ser. No. 12/291,646, entitled “Plasma generating system having tunable plasma nozzle,” filed on Nov. 12, 2008, which is herein incorporated by reference in its entirety. For brevity, a nozzle having a mechanism to move the rod-shaped conductor similar to the mechanism described in the copending U.S. patent application Ser. No. 12/291,646, is not shown in the present document.

FIG. 5 shows a schematic diagram of an NOx generating system 80 in accordance with yet another embodiment of the present invention which has parts configured and arranged as in the first and second embodiments of FIGS. 1-4 except for differences noted herein. As depicted, the system 80 includes: a microwave cavity/waveguide 82; a microwave supply unit 81 for providing microwave energy to the microwave waveguide 82; a gas flow tube 90 extending through the waveguide 82; a chamber 84 coupled to the exit of the gas flow tube 90 and adapted to receive and contain the gas that exits the gas flow tube 90; a pump 92 for recirculating the NOx containing gas contained in the chamber 84 via a recirculation gas line 94; a sensor 87 for measuring the NOx concentration in the chamber 84; an inlet valve 83; and an outlet valve 85; and, optionally, a sliding short circuit 88 disposed at the end of the waveguide 82.

The gas flow tube 90 may be formed of dielectric material, such as quartz, transparent to the microwave energy. The inlet of the gas flow tube 90 is coupled to the recirculation gas line 94. As the gas flows through the gas flow tube 90, the gas is excited by the microwave energy in the waveguide 82 and subject to chemical reactions. Depending on the intensity of the microwave energy in the waveguide 82, plasma 86 may be ignited in the gas flow tube 90.

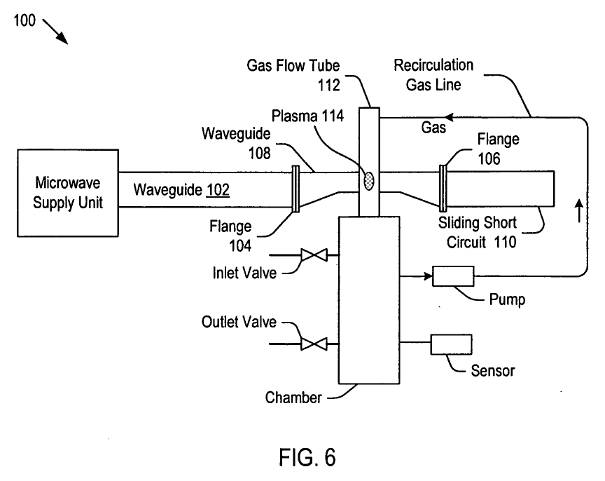

FIG. 6 shows a schematic diagram of an NOx generating system 100 in accordance with still another embodiment of the present invention which has parts configured and arranged as in the above embodiment of FIG. 5 except for differences noted herein. As depicted, the system 100 is similar to the system 80, with the difference that an additional waveguide 108 is disposed between a waveguide 102 and a sliding short circuit 110 by use of flanges 104, 106. The cross-sectional dimension of the waveguide 108 is varied along the direction of the microwave propagation to enhance the microwave energy intensity per area near the location where the gas flow tube 112 passes and to thereby reduce the threshold microwave intensity required to ignite plasma 114 in the gas flow tube 112.

Having described preferred embodiments of the invention with reference to the accompanying drawings, it is to be understood that the invention is not limited to those precise embodiments, and that various changes and modifications may be effected therein by one skilled in the art without departing from the scope or spirit of the inventions defined in the appended claims. Such modifications include substitution of components for components specifically identified herein, wherein the substitute component provides functional results which permit the overall functional operation of the present invention to be maintained. Such substitutions are intended to encompass as replacements for components and components yet to be developed which are accepted as replacements for components identified herein and which produce results compatible with operation of the present invention. Furthermore, the signals used in this invention are considered to encompass any electromagnetic wave transmission.

What is claimed is:

1. A system for generating a target gas by using microwave energy, comprising:
a chamber for containing gas;
a gas converting device having a gas inlet and a gas outlet connected to the chamber and adapted to convert gas received through the gas inlet into a target gas and to eject the target gas into the chamber through the gas outlet; and
a gas recirculating mechanism coupled to the chamber and the gas inlet of the converting means and operative to move the gas contained in the chamber to the gas inlet of the converting means.

2. A system as recited in claim 1, wherein the gas converting device is configured to apply microwave energy to effect gas conversion and comprises:
at least one nozzle including:
a housing having a generally cylindrical space formed therein, the space forming a gas flow passageway; and
a rod-shaped conductor disposed in the space and operative to transmit microwave energy along a surface thereof so that the microwave energy transmitting along the surface excites gas flowing through the space.

3. A system as recited in claim 2, wherein the housing includes a through hole as the gas inlet.

4. A system as recited in claim 2, further comprising a waveguide in which a portion of the rod-shaped conductor is disposed and to which the nozzle is secured.

5. A system as recited in claim 2, further comprising an electrical insulator disposed in the space and adapted to hold the rod-shaped conductor relative to the housing.

6. A system as recited in claim 1, wherein the gas recirculating mechanism comprises:
a gas line having one end operatively connected to the chamber and another end operatively connected to the gas inlet of the converting means; and
a pump disposed in the gas line and operative to generate a gas flow in the gas line.

7. A system as recited in claim 1, further comprising a sensor for measuring a concentration of the target gas in the chamber.

8. A system as recited in claim 1, wherein the target gas is selected from the group consisting of NO₂, NO, CO₂, ClO₂, SO₂, H₂O₂, O₃, EtO, and any mixture thereof.

9. A system as recited in claim 1, wherein the gas converting device comprises:
a microwave cavity for containing microwave energy;
a tube formed of material transparent to microwave energy and passing through the cavity and having two ends corresponding to the gas inlet and the gas outlet, respectively; and
the microwave cavity containing sufficient microwave energy such that gas flowing through the tube is excited by the microwave energy contained in the microwave cavity when the gas passes through the microwave cavity.

10. A system as recited in claim 9, wherein a cross-sectional dimension of the microwave cavity is reduced at a location nearby the tube.

11. A system as recited in claim 9, wherein the tube is formed of dielectric material.

12. A system as recited in claim 9, wherein the gas flowing through the tube is excited into plasma when the gas passes through the microwave cavity.

13. A system for generating a target gas, comprising:
a microwave generator for generating microwave energy;
a power supply connected to the microwave generator for providing power thereto;
a microwave cavity;
a waveguide operatively connected to the microwave cavity for transmitting microwave energy thereto from the microwave generator;
an isolator for dissipating microwave energy reflected from the microwave cavity;
at least one nozzle coupled to the microwave cavity and including:
a housing having a generally cylindrical space formed therein and a through hole, the space forming a gas flow passageway and being in fluid communication with the through hole; and
a rod-shaped conductor disposed in the space and having a portion extending into the microwave cavity for receiving microwave energy and operative to transmit microwave energy along a surface thereof so that the microwave energy transmitted along the surface excites gas flowing through the space into the target gas;
a chamber operatively coupled to the space and adapted to receive the target gas from the nozzle; and
a gas recirculating mechanism coupled to the chamber and the through hole formed in the housing and operative to move the gas contained in the chamber to the through hole.

14. A system as recited in claim 13, wherein the gas recirculating device comprises:
a gas line having one end operatively connected to the chamber and another end operatively connected to the through hole formed in the housing; and
a pump disposed in the gas line and operative to generate a gas flow in the gas line.

15. A system as recited in claim 13, further comprising a sensor for measuring a concentration of the target gas in the chamber.

16. A system for generating a target gas, comprising:
a microwave generator for generating microwave energy;
a power supply connected to the microwave generator for providing power thereto;
a microwave cavity;
a waveguide operatively connected to the microwave cavity for transmitting microwave energy thereto from the microwave generator;
an isolator for dissipating microwave energy reflected from the microwave cavity; a chamber for containing gas;
a tube formed of material transparent to microwave and passing through the cavity and having an upstream end and a downstream end and configured to convert gas flowing therethrough into a target gas by use of the microwave energy in the microwave cavity;
said chamber operatively coupled to the downstream end of the tube and adapted to receive the target gas from the tube; and
a gas recirculating mechanism coupled to the chamber and the upstream end of the tube and operative to move the gas contained in the chamber to the upstream end of the tube.

17. A system as recited in claim 16, wherein the gas recirculating mechanism comprises:
a gas line having one end operatively connected to the chamber and another end operatively connected to the upstream end of the tube; and
a pump disposed in the gas line and operative to generate a gas flow in the gas line.

18. A system as recited in claim 16, further comprising a sensor for measuring a concentration of the target gas in the chamber.
